(19) United States
(12) Patent Application Publication
(10) Pub. No.: US 2010/0119739 A1
(43) Pub. Date: May 13, 2010

(54) THERMAL TRANSFER PRINTING

(75) Inventors: Nicholas Clement Beck, Essex (GB); Anthony Joseph Martino, Suffolk (GB)

Correspondence Address: KENYON & KENYON LLP, ONE BROADWAY, NEW YORK, NY, 10004, US

(73) Assignee: Akzo Nobel Coatings International B.V.

(21) Appl. No.: 12/516,522

(22) PCT Filed: Nov. 28, 2007
(86) PCT No.: PCT/GB2007/004558

§ 371 Date: May 27, 2009

(30) Foreign Application Priority Data
Dec. 1, 2006 (GB) 0623997.4

(51) Int. Cl. B41M 5/035; B41M 5/382; B41M 5/52; B41M 5/025

(52) U.S. Cl. 428/32.51; 156/234; 428/195.1

(57) ABSTRACT

A retransfer intermediate sheet for receiving an image to be printed onto an article by thermal retransfer comprises a substrate; and an image-receiving coating on one side of the substrate for receiving an image by printing of dye-containing ink, the coating comprising a fluid-absorbing layer and a superposed dye management layer comprising functionalised polyvinyl alcohol and/or an ionic polymer. The dye management layer functions to reduce back diffusion and to increase dye transfer efficiency, resulting in production of printed images of improved optical density. The sheet can be heat-deformable, and finds particular use in printing on 3D articles, e.g. being heated and vacuum formed to conform to an article. The invention also covers a method of printing and an article bearing a printed image.

### FIELD OF THE INVENTION

This invention relates to thermal transfer printing, and concerns a retransfer intermediate sheet for receiving an image to be printed onto an article by thermal retransfer, a method of printing and an article bearing a printed image.

### BACKGROUND TO THE INVENTION

Thermal retransfer printing involves forming an image (in reverse) on a retransfer intermediate sheet using one or more thermally transferable dyes. The image is then thermally transferred to a surface of an article by bringing the image into contact with the article surface and applying heat and possibly also pressure. Thermal transfer printing is particularly useful for printing onto articles that are not readily susceptible to being printed on directly, particularly three dimensional (3D) objects. Thermal retransfer printing by dye diffusion thermal transfer printing, using sublimation dyes, is disclosed, e.g., in WO 98/02315 and WO 02/096661. By using digital printing techniques to form the image on the retransfer intermediate sheet, high quality images, possibly of photographic quality, can be printed on 3D articles relatively conveniently and economically even in short runs. Indeed such objects can be personalised economically.

The image on the retransfer intermediate sheet can be formed by thermal transfer printing, e.g. as disclosed in WO 98/02315 and WO 02/096661. It is also possible to form the image on the retransfer intermediate sheet by inkjet printing using sublimation dyes. The media typically used for such retransfer printing comprises a paper substrate coated with layers which can absorb and then release the dyes printed in the inkjet process, e.g. as disclosed in EP 1102682. This type of material is very effective in transferring images to articles that are flat in two dimensions. However this material is not effective in transferring images to three dimensional objects. This is because the substrate used in the media is not flexible enough to form around the object without creasing and distorting. This results in uneven contact between the active surfaces, and prevents good transfer of the image onto the surface of the article to be decorated.

To overcome the problem of poor contact between active surfaces when attempting to retransfer printed images onto 3D articles, thermoformable substrates have been employed in place of a paper substrate. Typically the substrate used is amorphous polyethylene terephthalate (PET), e.g. as disclosed in WO 01/96123 and WO 2004/022354, which is an extensible material (i.e. having the ability to be extended or protruded). Amorphous PET is a fully extensible material and is normally thermoformed at temperatures between 120 to 160° C. A problem often encountered in using such material is that the sublimation dyes typically used in this type of printing are very compatible with the substrate and with materials used in fluid-absorbing layers on the substrate. Consequently, when carrying out the final thermal retransfer step, the dyes can move into the substrate as well as transferring into the surface of the article being decorated, in a process called back diffusion. This means that not all the dye printed into the retransfer sheet is transferred to the final article, and limits the optical density achievable in the final image. As a result, images transferred lack contrast and are therefore perceived as being of low quality. To avoid back diffusion of dye into the substrate, a barrier layer can be applied between the ink absorbing layer and the substrate. These barrier coatings are typically applied by sputtering of thin layers of metals such as aluminum. This adds substantially to the cost of the sheet assembly. In addition, such barrier layers tend not to be very effective because they do not control dye movement and allow migration into the fluid absorbing layers of the sheets.

### SUMMARY OF THE INVENTION

In one aspect, the present invention provides a retransfer intermediate sheet for receiving an image to be printed onto an article by thermal retransfer, the sheet comprising a substrate; and an image-receiving coating on one side of the substrate for receiving an image by printing of dye-containing ink, the coating comprising a fluid-absorbing layer and a superposed dye management layer comprising a functionalised polyvinyl alcohol and/or an ionic polymer.

In use, an image to be printed is fanned (in reverse) on the image-receiving coating of the retransfer intermediate sheet by printing using dye-based inks. Suitable inks are often termed sublimation inks, although transfer can occur by diffusion or sublimation, or a mixture of both, depending on the degree of surface contact. Such inks usually incorporate the sublimation dyes in the form of a pigment dispersion. The image may be formed by a variety of printing techniques including screen printing, flexo printing, etc. It is preferred to use digital printing techniques, particularly inkjet printing. Suitable inkjet printable sublimation dyes, having appropriate physical properties such as viscosity etc. to be inkjet printable, are commercially available, e.g. for use with Epson (Epson is a Trade Mark) and other makes of inkjet printer. The dye management layer can function to capture dye components in applied inks and hold these components close to the sheet surface, while allowing ink fluids to pass to the fluid-absorbing layer. The sheet is then placed with the image-receiving coating in contact with the surface of the article onto which it is desired to print, with the application of heat (and usually also pressure) resulting in dyes from the retransfer donor sheet transferring to the article surface to produce the desired printed image. The dye management layer can function to reduce back-diffusion of dye molecules towards the substrate as the sheet is heated, thus increasing the dye available for retransfer and so improving optical density in the final image. The invention can thus enable production of images of better definition and density than possible hitherto. In addition, the improved retransfer efficiency means the sheets can be used to print on a wider range of materials than would otherwise be the case.

We have found that to achieve high transfer efficiency with retransfer sheets or films, dye movement within the coat structure has to be managed. If dyes are allowed to migrate away from the surface, into the coatings below (during either the inkjet printing or thermal transfer stage), they cannot participate in the transfer process. This results in retransferred images with lower definition and a washed-out appearance. Low efficiency retransfer films also limit the range of materials which can be decorated successfully.

In the present invention, specific materials have been identified which improve the barrier properties of these films. These materials are suitably used in the uppermost layer of the film. The advantage of this approach is that sublimation dye pigments can become trapped in the management layer and are therefore concentrated closer to the transfer interface. A greater proportion of the dye is then available for retransfer into suitably receptive surfaces.

Many materials are described as having dye barrier properties. This is often because they have the ability to capture ink pigments. They are, however, often less effective during thermal retransfer, because they are unable to prevent back-diffusion. The dye management layer employed in this invention can be capable of reducing dye migration at both transfer stages.

In preferred embodiments at least, the barrier materials must be capable of minimising dye migration after the film is thermoformed around an object.

With thermal retransfer sheets in accordance with the invention, because more dye is available for retransfer, less dye can be retained in the sheet after use and retransfer efficiencies of at least 75%, and possibly at least 80% (under optimum process conditions) have been obtained.

In a further aspect the invention provides a retransfer intermediate sheet for receiving an image to be printed onto an article by thermal retransfer, the sheet comprising a substrate; and an image-receiving coating on one side of the substrate for receiving an image by printing, preferably inkjet printing, of dye-containing ink, the coating comprising a fluid-absorbing layer and a superposed dye management layer, wherein the sheet is capable of at least 75% dye retransfer efficiency.

The functionalised polyvinyl alcohol is preferably a silanized polyvinyl alcohol, that may be hydrolysed (fully or partially). Suitable materials are available commercially, typically being available in a range of grades of different molecular weights, and good results have been obtained with fully hydrolysed silanized polyvinyl alcohol, e.g. in the form of Polyviol P6060 (Polyviol is a Trade Mark) from Wacker Polymers, which has a viscosity of 30 mPa·s for a 4% solution in water.

The dye management layer (in dry condition) conveniently comprises functionalised polyvinyl alcohol (e.g. fully hydrolysed silanized polyvinyl alcohol) in an amount in the range 30 to 100% by weight of the dry coating, e.g. about 80% by weight, with any balance conveniently being constituted by a non-ionic polymer, preferably non-functionalised polyvinyl alcohol desirably with a low degree of hydrolysis (e.g. below 85%). Such materials have a beneficial effect on the extensibility and rheology of the layer, as discussed below. Good results have been obtained using the non-ionic polymer Celvol W25/190 (Celvol is a Trade Mark) from Celanese Chemicals, which is a polyvinyl alcohol resin with a 81-84% degree of hydrolysis.

The ionic polymer may be selected from materials including alginates, copolymers of styrene and maleic anhydride, and carboxymethylcellulose, and is conveniently in the form of a metal salt, particularly of a sodium salt. The currently preferred material is sodium carboxymethylcellulose. Sodium carboxymethylcellulose is commercially available in three degrees of substitution (0.7, 0.9 and 1.2) and a wide range of molecular weights. Good results have been obtained with Walocel CRT 30 (Walocel is a Trade Mark) from Wolff Cellulosics, which is a low viscosity sodium carboxymethylcellulose with a 0.9 degree of substitution. The viscosity of Walocel CRT 30 is 30 mPa·s for a 2% solution in water.

The dye management layer (in dry condition) conveniently comprises ionic polymer (e.g. sodium carboxymethylcellulose) in an amount in the range 30 to 100% by weight of the dry coating, e.g. about 50% (say 48%), with any balance being constituted by a non-ionic polymer, as discussed above in connection with layers comprising functionalised, polyvinyl alcohol, and/or a small amount of plasticiser, such as polyethylene glycol (preferably with a molecular weight of less than 600), sorbitol or glycerol, with glycerol being preferred. Again, such materials have a beneficial effect on the extensibility and rheology of the layer.

Mixtures of functionalised polyvinyl alcohols and/or ionic polymers may be used in the dye management layer.

The dye management layer is preferably the uppermost layer of the sheet.

The dye management layer suitably has a dry thickness in the range 0.5 to 7 microns, preferably 1.5 to 6.5 microns.

The dye management layer desirably comprises a flocculating agent and/or a coagulant which assists the pigmented ink to precipitate on contact with the article surface. Such materials reduce the interaction between neighbouring ink drops of different colour, increasing the sharpness and uniformity of the print. Examples of such materials are polyDADMAC (polydiallyldimethyl ammonium chloride), preferably of molecular weight 400,000 to 500,000 and trivalent and divalent metal salts such as aluminum sulphate and magnesium chloride.

If present, flocculating agent and/or coagulant are present at a level, in total, of 5 wt % of the coating solids in the dye management layer.

The invention finds particular application in retransfer intermediate sheets which are useful in forming images on 3D articles as described above. Such sheets utilise deformable substrates, commonly PET, with which sublimation dyes are very compatible. To form an image on a typical 3D object the retransfer intermediate sheet, including the substrate on which it is coated, must be able to tolerate being stretched without fracture. Experience we have obtained when decorating a range of objects has determined that areas of the donor sheet need to be able to stretch to about three times their original length without cracking in order to decorate all the object surfaces. This is equivalent to a dimensional change of at least 200%. In such embodiments, the substrate and image-receiving coating are designed with these requirements in mind, with both components being able to deform sufficiently when suitably heated.

The heat-deformable substrate thus suitably comprises material that is deformable when heated, typically to a temperature in the range 80 to 170° C., preferably being sufficiently deformable to be vacuum formed under the action of heat. It is preferred to use substrates that will deform at as low a temperature as possible in order to be able to print on thermally sensitive materials, although it is more difficult to manufacture coated products using such substrates. The substrate preferably comprises an amorphous (non-crystalline) polyester, particularly amorphous polyethylene terephthalate (APET), as such materials have low heat-deformation temperatures. The substrate is typically in the form of a sheet or film and desirably has a thickness in the range 100 to 250 microns, e.g. about 150 microns. Good results have been obtained with a clear 150 micron thick amorphous grade of polyethylene terephthalate known by the Trade Mark PET ‘A’ supplied by Ineos Vinyls. It is more difficult to deform thicker grades around complex articles. Other substrate materials are available but some are less desirable; for example polyvinylchloride (PVC) films may be used but these can contain high levels of plasticiser which may tend to transfer into the article being treated, which is undesirable.

For sheets for use in forming images on 3D articles, the image-receiving coating should be similarly deformable, and this is achieved by use of materials having appropriate extensibility, if necessary modified by use of resins and/or plasticisers. In particular, the following materials have been found useful in this respect, as discussed above: a non-ionic polymer, preferably polyvinyl alcohol, most preferably polyvinyl alcohol with a low degree of hydrolysis such as Celvol W25/190 referred to above; and a water-soluble plasticizer, which is either polyethylene glycol (preferably with a molecular weight of less than 600) or glycerol, with glycerol being preferred.

The fluid-absorbing layer functions to absorb fluid components in applied ink. The layer should desirably have sufficient capacity to absorb rapidly all aqueous and non-aqueous solvents in the ink. This layer desirably comprises an amorphous porous silica gel to absorb the liquid ink components; a first, non-dyestuff absorbing polymeric binder component that reduces the retention of dyestuff in the sheet during sublimation transfer; and a second, flexible polymeric binder that provides flexibility during heat deformation, preventing cracking of the layer. Such layers are deformable and extensible and so are suited to use in sheets intended for formation of images on 3D articles, as discussed above.

The preferred fluid-absorbing layer thus comprises a mixture of two compatible polymeric binders with particles of amorphous porous silica gel dispersed therethrough, preferably being reasonably homogeneous in composition. The layer is designed to be suitable for printing with inks containing sublimation dyes, for subsequent thermal transfer to an article. The layer is designed to be able to receive an image by inkjet printing, with the amorphous porous silica gel functioning to absorb liquid ink components. The first, non-dye absorbing polymeric binder functions to reduce the retention of the dye in the retransfer intermediate sheet on subsequent sublimation transfer. The second, flexible polymeric binder functions to provide flexibility on heating and deformation, preventing cracking of the layer, and also absorbs liquid components of the applied ink.

Amorphous porous silica gel has good absorption properties and is effective in absorbing a wide range of fluids including oil and water. It is preferred to use amorphous porous silica gel having an oil absorption characteristic (namely the amount of oil in grams that can be absorbed into 100 grams of silica gel) in the range 25 to 150 grams of oil per 100 grams of silica, more preferably at least 50 grams of oil per 100 grams of silica. The silica gel preferably has an average particle size in the range 10 to 20 microns. Good results have been obtained using Syloid W900 (Syloid is a Trade Mark) silica gel from Grace Davison. This is a porous, pre-wetted (55% water by weight) grade of amorphous silica filler with an average particle size of 13 microns and an oil absorption characteristic of about 75 grams of oil per 100 grams of silica.

The amorphous porous silica gel is typically present in an amount in the range 10 to 35%, preferably 15 to 25%, by weight of the total dry weight of the fluid-absorbing layer.

The first, non-dye absorbing polymeric binder forms part of the main polymeric binder structure which binds together the amorphous porous silica gel particles and also participates in absorbing liquid components of the ink. Good results have been obtained with hydrolysed polyvinyl alcohols, preferably fully-hydrolysed polyvinyl alcohols, which do not absorb the types of dye used for sublimation transfer even when heated. It is preferred to use hydrolysed polyvinyl alcohols with relatively low molecular weights, and hence viscosities, for ease of coating. Suitable hydrolysed polyvinyl alcohols are commercially available, e.g. in the form of Mowiol 4/98 (Mowiol is a Trade Mark), which is a fully hydrolysed grade of polyvinyl alcohol with a low molecular weight (27,000) available from Kuraray Co. Ltd.

The first, non-dye absorbing polymeric binder is typically present in an amount in the range 15 to 30%, preferably 20 to 25%, by weight of the total dry weight of the fluid-absorbing layer.

The second, flexible polymeric binder also forms part of the main polymeric binder structure which binds together the amorphous silica gel particles. This binder also prevents the layer from cracking during thermal deformation (typically up to 200%), and participates in absorbing the liquid components of the ink. The flexible binder is thus desirably capable of absorbing water to an extent to allow sufficient and rapid absorption of ink solvents during printing. Suitable binder materials include polyoxazolines (poly(2-ethyl-2-oxazoline)) and aqueous polyurethane dispersions, with poly(2-ethyl-2-oxazoline) being preferred currently. Poly(2-ethyl-2-oxazoline) is commercially available in a range of grades of different molecular weights, e.g. from 5,000 to 500,000, for instance as supplied by International Speciality Products (ISP) under the Trade Mark Aquazol. Good results have been obtained with Aquazol 50, which is a poly(2-ethyl-2-oxazoline) resin having a molecular weight of 50,000: this produces an image-receiving layer with good properties without having undesirably high solution viscosity.

The second, flexible polymeric binder is typically present in an amount in the range 35 to 65%, preferably 45 to 55%, by weight of the total dry weight of the fluid-absorbing layer.

The fluid absorbing layer suitably has a thickness in the range 10 to 20 microns, e.g. about 15 microns.

The image-receiving coating may include an optional prime layer between the substrate and the fluid-absorbing layer. The prime layer improves adhesion of the fluid-absorbing layer to the substrate, and suitably comprises a flexible polymeric material. In general the flexible polymeric material should be more flexible than the fluid-absorbing layer to prevent loss of adhesion on deformation. Suitable flexible polymeric materials include aqueous dispersions of polyester resins of low glass transition temperature (Tg), i.e. having a Tg of less than 50° C., such as those supplied by Toyobo under the Trade Mark Vylonal, e.g. having a Tg of 20° C. Such polyester resins adhere well to amorphous polyester substrates. Such polyester resins generally have greater flexibility than the second, flexible polymeric binder, although this is not essential.

The sheet may include an optional flexible interlayer between the fluid-absorbing layer and the dye management layer. This layer is designed to prevent or minimise the dye management layer from being absorbed into the fluid-absorbing layer during manufacture.

The interlayer suitably comprises a non-ionic polymer, preferably a thermoformable non-ionic polymer, most preferably a polyvinyl alcohol with a low degree of hydrolysis, e.g. less than 85%, such as Celvol W25/190 referred to above.

The interlayer suitably has a thickness in the range 0.2 to 3.0 microns, preferably from 0.5 to 1.0 microns. The interlayer conveniently also comprises a plasticizer such as polyethylene glycol (preferably with a molecular weight of less than 600), glycerol or sorbitol, with glycerol being preferred. One preferred composition of interlayer (in dry condition) comprises about ⅔ by weight Celvol W25/190 and about ⅓ by weight glycerol.

In embodiments of the invention employing heat-deformable substrates and a flexible polymeric binder in the fluid-absorbing layer, the sheets find particular application in printing on 3D articles, possibly having complex shapes including curved shapes (concave or convex) including compound curves. When printing onto 3D articles, the sheet is typically preheated, e.g. to a temperature in the range 80 to 170° C., prior to application to the article, to soften the sheet and render it deformable. The softened sheet is then in a condition in which it can be easily applied to and conform to the contours of an article. This is conveniently effected by application of a vacuum to cause the softened sheet to mould to the article. While the sheet is maintained in contact with the article, e.g. by maintenance of the vacuum, the sheet, and possibly also the article, is heated to a suitable temperature for dye transfer, typically a temperature in the range 140 to 200° C., for a suitable time, typically in the range 15 to 150 seconds. After dye transfer, the article is allowed or caused to cool before removal of the retransfer intermediate sheet. Suitable apparatus for performing the retransfer printing step is known, e.g. as disclosed in WO 01/96123 and WO 2004/022354.

The retransfer intermediate sheet of the invention finds particular application in use with thermal image retransfer equipment to decorate the surface of 3D objects. The objects can be made of a wide range of rigid materials including plastics, metal, ceramic, wood and other composite materials, with the objects either being of solid or thin-walled construction. One example of its use is in the decoration of automotive trim panels to enhance their surface appearance, but there are many other possible applications.

Depending on the nature of the surface of the article on which an image is to be formed, it may be appropriate to pre-treat the surface by application of a surface coating or lacquer to improve the take-up of transferred dyes. Suitable dye receptive lacquers and their method of use are known to those skilled in the art, e.g. as disclosed in EP 1392517. A lacquer is typically applied by spray coating, followed by oven curing at 90° C. for 50 minutes.

The invention also includes within its scope a method of printing an image on an article using a retransfer intermediate sheet in accordance with the invention, comprising forming an image by printing, preferably inkjet printing, on the image-receiving coating of the sheet, bringing the coating into contact with a surface of the article and applying heat to cause thermal transfer of the image from the sheet to the article surface.

The invention also covers an article bearing a printed image produced by the method of the invention.

The invention, in preferred embodiments at least, has a number of advantages including the following:
The ability to decorate 2D and 3D objects with photographic quality images. Because the film and coatings are fully extensible, complex 3D shapes can be decorated effectively.
The ability to decorate many thermoplastics materials without pretreatment, including temperature sensitive materials such as high density polyethylene (HDPE).
The ability to decorate a wide range of other materials, including metals, glass, ceramics and wood. These materials may require pretreatment.
The ability to achieve images of high densities with reduced ink loading of the retransfer sheet.
The ability to manufacture the retransfer sheet economically using conventional coating techniques.

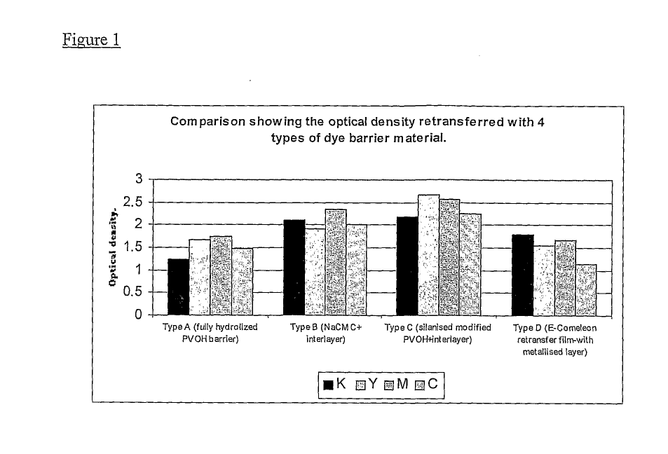

Preferred embodiments of the invention will now be described, by way of illustration, in the following examples. All percentages are by weight unless otherwise stated. The examples refer to FIG. 1 which is a bar chart comparison of the optical density of images retransferred with four different thermal retransfer sheets having different dye management or dye barrier layers.

### EXAMPLES

### Example 1 (Type B)

One embodiment of a heat-deformable retransfer intermediate sheet in accordance with the present invention was prepared as described below. The sheet comprised a heat-deformable substrate coated sequentially with a prime layer, a fluid absorbing layer, a flexible interlayer and a dye management layer.

Substrate

The substrate comprised A3 size sheets of PET ‘A’, a clear 150 micron thick amorphous grade of polyethylene terephthalate film supplied by Ineos Vinyl.

The following coatings were applied in sequence using a number 4 Meyer bar. All coatings were oven dried at 60° C.

Prime Layer

A polyester resin having a Tg of less than 50° C. in the form of an aqueous dispersion (Vylonal MD-1400 from Toyobo) was applied to the substrate to produce a coat 1 micron thick. The resin is highly flexible and allows the fluid absorbing layer to adhere to the substrate.

Fluid-Absorbing Layer

The fluid absorbing layer was prepared from the following formulation.

Deionised water—64.5%

Mowiol 4/98—4.5% (first binder)

Aquazol 50—10% (second binder)

Methanol—10% (solvent)

Syloid W900—11% (amorphous porous silica gel)

The formulation was prepared as follows:

Cold deionised water was measured into a mixer fitted with a heater jacket. The Mowiol 4/98 resin was then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C. The Aquazol 50 binder and methanol were then added and the solution was mixed for a further 2 hours.

The final stage in the solution preparation process is the dispersion of the Syloid W900 silica. To ensure this filler is fully de-agglomerated and reduced to its primary particles, relatively high shear forces are required during the mixing process. This stage was therefore carried out using a saw-tooth type dispersing head, operating at a tip speed of 5-6 m/sec. The Syloid W900 silica was added into the vortex created by the dispersing head and mixed for 60 minutes.

A 15 micron thickness coating was formed on the primed surface of the substrate producing the fluid-absorbing layer.

Flexible Interlayer

The flexible interlayer was prepared from the following formulation.

Deionised water—87%

Celvol W25/190—8.7% (polyvinyl alcohol resin with a low degree of hydrolysis)

Glycerol—4.3% (ex Aldrich) (water soluble plasticizer)

The formulation was prepared as follows:

Cold deionised water was measured into a mixer fitted with a heater jacket. The Celvol W25/190 resin was then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C. The glycerol was then added and the solution was mixed.

A coating 3 microns thick was formed on the fluid-absorbing layer.

Dye Management Layer

The dye management layer was prepared from the following formulation.

Deionised water—90.3%

Celvol W25/190—4.1% (polyvinyl alcohol resin)

Walocel CRT 30—4.8% (sodium carboxymethylcellulose)

Glycerol—0.8% (plasticizer)

The formulation was prepared as follows:

Cold deionised water was measured into a mixer fitted with a heater jacket. The Celvol W25/190 resin was then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C. The Walocel CRT 30 and glycerol were then added and the solution was mixed.

A coating 2.5 microns thick of the dye management layer was formed on the flexible interlayer. The dye management layer (in dry condition) comprised about 50% Walocel CRT, 42% Celvol W25/190 and 8% glycerol.

### Example 2 (Type C)

A further embodiment of heat-deformable retransfer sheet in accordance with the invention was prepared as described in Example 1, but using a different dye management layer and a different flexible interlayer.

The flexible interlayer was prepared from the following formulation.

Deionised water—76%

Industrial methylated spirit—20%

Celvol W25/190—4% (polyvinyl alcohol resin)

The formulation was prepared as follows:

Cold deionised water was measured into a mixer fitted with a heater jacket. The Celvol W25/190 resin was then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C. The industrial methylated spirit was then added and the solution was mixed.

A coating 0.5 microns thick was formed on the fluid-absorbing layer.

The dye-management layer was prepared from the following formulation.

Deionised water—90%

Celvol W25/190—2% (polyvinyl alcohol resin)

Polyviol P6060—8% (fully hydrolysed silanized polyvinyl alcohol)

The formulation was prepared as follows

Cold deionised water was measured into a mixer fitted with a heater jacket. The Celvol W25/190 and Polyviol P6060 were then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C.

A coating 3.5 microns thick of the dye management layer was formed on the flexible interlayer. The dye management layer (in dry condition) comprised 80% Polyviol P6060 and 20% Celvol W25/19.

### Example 3 (Type A)

A further heat deformable retransfer sheet, not in accordance with the invention, with a dye management layer based on fully hydrolysed polyvinyl alcohol was prepared generally as described in Example 1 for comparative purposes.

A dye management layer with a coat thickness 1.5 micron was produced using the following formulation.

Deionised water—94.8%

Mowiol 20/98—5% (binder)

Syloid ED3—0.17% (amorphous porous silica gel)

The formulation was prepared as follows:

Cold deionised water was measured into a mixer fitted with a heater jacket. The Mowiol 20/98 resin was then dispersed into the cold deionised water using a paddle mixer. Using the heater jacket, the solution temperature was then raised to 95° C. The solution temperature was maintained at this level for a further 30 minutes to ensure complete solvation. The solution was then cooled to 25° C.

The final stage in the solution preparation process is the dispersion of the Syloid ED3 silica. To ensure this filler is fully de-agglomerated and reduced to its primary particles, relatively high shear forces are required during the mixing process. This stage was therefore carried out using a saw-tooth type dispersing head, operating at a tip speed of 5-6 m/sec. The Syloid ED3 silica was added into the vortex created by the dispersing head and mixed for 60 minutes

### Example 4

Comparative tests were carried out on the sheets of Examples 1 to 3, and also a commercially available competitive retransfer film known as 3D Image Foil supplied by E-Comeleon, having a metallized layer applied to an amorphous PET substrate surface (Type D).

The four different types of sheets (A, B, C and D) were then printed with test patterns using an Epson 4400 (Epson is a Trade Mark) ink jet printer, fitted with ArTainium (ArTainium is a Trade Mark) sublimation inks available from Sawgrass Technologies Inc. The test pattern contained colour blocks of black, yellow, magenta and cyan, which were printed at full density.

To provide a receptive receiver for the retransfer of test images, a series of test plaques were prepared. These consisted of sheets of white PET (thickness 250 microns) coated with a dye receptive lacquer. R6064 lacquer (manufactured by ICI Imagedata) was prepared by adding crosslinker and thinners according to the supplied instructions. A number 3 Meyer bar was used to apply this lacquer to the sheets to achieve a dry coat thickness of 25 microns. The lacquer was then cured at 90° C. for 50 minutes to crosslink the coating.

The test patterns on the donor sheets were then retransferred into the test plaques to establish the efficiency of the various barrier materials. The retransfer process was carried out using a Clark PF420/3H Pictaflex vacuum press (Clark and Pictaflex are Trade Marks) operating at a transfer temperature of 160° C.

The density of each retransferred colour block was then measured using a Spectroeye densitometer (Spectroeye is a Trade Mark) and the results are shown in FIG. 1.

FIG. 1 shows the optical density for the different ink colour blocks black (K), yellow (Y), magenta (M) and cyan (C). It can be seen that superior results are obtained with the two sheets (Type B and Type C) in accordance with the invention.

The ‘spent’ donor sheets were also visually examined to estimate the amount of dye retained in the coating. This is indicative of the degree of back-diffusion that is taking place. It was estimated that sheets prepared with a sodium carboxymethylcellulose (Type B) or silanized polyvinyl alcohol (Type C) management coatings retained less than 20% of the dye. The sheets which used a fully hydrolysed polyvinyl alcohol barrier (Type A) had significantly higher proportions of retained dye, and this was estimated to be about 50%. The competitive material (Type D) with a metallized layer retained about 30% of the dye.

1. A retransfer intermediate sheet for receiving an image to be printed onto an article by thermal retransfer, the sheet comprising a substrate; and an image-receiving coating on one side of the substrate for receiving an image by printing of dye-containing ink, the coating comprising a fluid-absorbing layer and a superposed dye management layer comprising a functionalised polyvinyl alcohol and/or an ionic polymer.

2. The sheet according to claim 1, wherein the dye management layer comprises silanized polyvinyl alcohol.

3. The sheet according to claim 2, wherein the silanized polyvinyl alcohol is fully hydrolysed.

4. The sheet according to claim 1, wherein the dye management layer comprises one or more ionic polymers selected from alginate, copolymers of styrene and maleic anhydride, and carboxymethylcellulose.

5. The sheet according to claim 4, wherein the dye management layer comprises a sodium salt of an ionic polymer.

6. The sheet according to claim 5, wherein the dye management layer comprises sodium carboxymethylcellulose.

7. The sheet according to claim 1, wherein the dye management layer further comprises a non-ionic polymer, and optionally a plasticizer.

8. The sheet according to claim 1, wherein the dye management layer has a thickness in the range 0.5 to 7 microns.

9. The sheet according to claim 1, wherein the dye management layer comprises a flocculating agent and/or a coagulant.

10. The sheet according to claim 1, wherein the substrate is heat deformable.

11. The sheet according to claim 10, wherein the substrate comprises amorphous polyethylene terephthalate.

12. The sheet according to claim 1, wherein the substrate comprises sheet or film having a thickness in the range 100 to 250 microns.

13. The sheet according to claim 1, including a prime layer between the substrate and the fluid-absorbing layer.

14. The sheet according to claim 1, including a flexible interlayer between the fluid-absorbing layer and the dye management layer.

15. The sheet according to claim 14, wherein the interlayer comprises a non-ionic polymer.

16. The sheet according to claim 15, wherein the interlayer comprises polyvinyl alcohol with a degree of hydrolysis of less than 85%.

17. The sheet according to claim 14, wherein the interlayer further comprises a plasticizer.

18. A retransfer intermediate sheet for receiving an image to be printed onto an article by thermal retransfer, the sheet comprising a substrate; and an image-receiving coating on one side of the substrate for receiving an image by printing of dye-containing ink, the coating comprising a fluid-absorbing layer and a superposed dye management layer, wherein the sheet is capable of at least 75% dye retransfer efficiency.

19. A method of printing an image on an article using a retransfer intermediate sheet in accordance with claim 1, comprising forming an image by printing on the image-receiving coating of the sheet, bringing the coating into contact with a surface of the article and applying heat to cause thermal transfer of the image from the sheet to the article surface.

20. An article bearing a printed image produced by the method of claim 19.

21. The sheet according to claim 7, wherein the dye management layer comprises non-functionalised polyvinyl alcohol.

22. The sheet according to claim 8, wherein the dye management layer has a thickness in the range 1.5 to 6.5 microns.

23. The sheet according to claim 12, wherein the substrate comprises sheet or film having a thickness about 150 microns.
